(19) United States
(12) Patent Application Publication
(10) Pub. No.: US 2004/0251329 A1
(43) Pub. Date: Dec. 16, 2004

(54) Grinding process for forming a slurry of nanoparticles

(75) Inventors: Ching-Tien Hsu, Tucheng City (TW); Yih-Her Chang, Hsinchu City (TW); Shu-Chen Tsou, Hsinchu City (TW); Wei-Yi Chien, Keelung City (TW); Shu-Ya Tsai, Hsinchu City (TW); Shi-Min Shau, Pusin Township (TW); Shou-I Chen, Hsinchu City (TW)

Correspondence Address: BACON & THOMAS, PLLC, 625 SLATERS LANE, FOURTH FLOOR, ALEXANDRIA, VA, 22314

(73) Assignee: Industrial Technology Research Institute, Hsinchu (TW)

(21) Appl. No.: 10/747,095

(22) Filed: Dec. 30, 2003

(30) Foreign Application Priority Data
Dec. 30, 2002 (TW) 091137897

(51) Int. Cl. B02C 1/00

(52) U.S. Cl. 241/15

(57) ABSTRACT

A grinding process for forming a slurry of nanoparticles, consists of the following steps: forming a mixture by mixing a matrix, a dispersant and dispersing media together; adding a pre-treated grinding-media into the mixture; wherein the grinding-media are glass beads with an average particle diameter of less than 100 □m; milling or grinding the mixture; and separating the grinding-media from the mixture to get a slurry of nanoparticles. A pigment dispersion produced from the grinding process illustrated above is also disclosed.

### BACKGROUND OF THE INVENTION

1. Field of the Invention

The present invention relates to a process for forming a slurry of dispersed particles and, more particularly, to a grinding process for forming a slurry of dispersed nanoparticles used for dying, colored-pigment-dispersing of a textile, or for dispersion of coatings, printing inks, organic or inorganic flame retardants, medicine powders or crystalline functional powders.

2. Description of Related Art

The dispersion of ultra-fine nanoparticles in slurry or in a solution is frequently achieved by the application of metal carbide of high hardness or polymeric grinding-media of low hardness. However, owing to the high hardness, the ultra-fine nanoparticles to be dispersed are frequently contaminated by the materials scratched from the tank when metal carbide is used as the grinding medium. The contamination of the nanoparticle solution by the scratched particles of the tank wall materials also results in color alteration of dispersed products, pollution caused by heavy metals, and unexpected changes in the acidity of the dispersed products. To avoid the drawbacks illustrated above, the application of hard surface tanks and hard grinding medium is common. However, the high price of both hard surface tanks and hard grinding media increases the cost very significantly. Therefore, hard surface tanks or hard grinding media are not satisfactory solutions to this problem of contamination of the nanoparticle slurry.

On the other hand, when the polymeric grinding media are used, many kinds of mixing bladders and tanks can be used since the possibility of abrasion on the tank walls is very low. Therefore, costs for dispersion of nanoparticles can be reduced effectively. However, since the hardness of the polymeric grinding media is low, only organic nanoparticles which are easy to be distributed or dissembled are suitable for the grinding through the polymeric grinding media. In addition, the low density of the polymeric media also results in low impact and the drifting phenomenon. Therefore, the effectiveness for dispersion is low. Furthermore, the low free energy of the surface on the particles of polymeric grinding media also increases the affinity of bubbles. Therefore, a combination of bubbles, grinding-media, and dispersed slurry stays in the slurry. The slurry appears locally stationary and becomes difficult to be agitated. In other words, the efficiency of dispersion for nanoparticles (<30 nm) through a polymeric grinding media is poor since the density of the grinding media is low.

### SUMMARY OF THE INVENTION

The object of the present invention is to provide a grinding process for forming nanoparticle slurry to reduce the cost for equipment, prevent the contamination and abrasion of grinding-media, and achieve high milling efficiency.

Another object of the prevent invention is to provide a grinding process for forming nanoparticle slurry to disperse the pigment powders at a nano-scale (<30 nm) so as to increase the color saturation and distribution of colors.

Another object of the present invention is to provide a pigment dispersion, wherein the pigment particles are in a nano-scale and well dispersed to increase the color saturation.

To achieve the object, the grinding process for forming a slurry of nanoparticles comprises the following steps: forming a mixture by mixing a matrix, a dispersant and a dispersing media together; adding a pre-treated grinding-media into said mixture; wherein said grinding-media are glass beads with an average particle diameter of less than 100 □m; milling or grinding said mixture; and separating said grinding-media from said mixture to achieve a slurry of nanoparticles.

The pigment dispersion of the present invention mainly comprises: 0.1 to 70 wt % of a pigment with an average particle diameter of less than 100 nm; 0.1 to 30 wt % of dispersant; and 40 to 90 wt % of water; wherein said pigment is formed by milling or grinding a mixture of a matrix, said dispersant and a dispersing media with glass beads with an average particle diameter of less than 100 □m.

Other objects, advantages, and novel features of the invention will become more apparent from the following detailed description when taken in conjunction with the accompanying drawings.

### BRIEF DESCRIPTION OF THE DRAWING

FIG. 1 shows the variation of dispersing particle size versus time for the pigment in embodiment 3.

### DETAILED DESCRIPTION OF THE PREFERRED EMBODIMENT

The grinding process for forming slurry of nanoparticles of the present invention utilizes glass beads with an average particle diameter of below 100 □m as a grinding-medium. Using a wet milling method, the powder desired to be dispersed, the dispersant facilitating dispersion and the dispersing media are mixed well, and said grinding-medium is then added in the mixture. The mixture is put in a stirring machine, such as a mill, which provides kinetic energy for grinding-media to collide with each other and thus to drive the mixture to generate shearing force and colliding force between fluid and solid or between solid and solid. Consequently, the powders dispersed in the grinding-media are refined. The milling machine includes a member to drive the grinding-media or provides energy to the grinding-media and a container to load the mixture desired to be dispersed and the grinding-media. The following description will illustrate the grinding-media, dispersing sequence, dispersing media, dispersant type, types of powder dispersed and dispersion.

The material for the grinding-media used in the process of the present invention is inorganic glass material with a density of 1 to 3 g/cm³, spherical in shape, and with only a small amount of irregularly-shaped components. If the amount of irregularly-shaped components is too high, it must be reduced, for example, by gravity sedimentation, filtering, sieving method. In addition, the grinding-media of the present invention may be combined with a single grain grinding-media with large particle size, low density and similar weight. Said grinding-media are typically polymer grinding-media. Preferably, the polymer grinding-medium is cross-linked polystyrenes, styrene copolymers, polycarbonates, polyacetals, vinyl chloride polymers and vinyl chloride/polychloroethylene copolymers, polyurethanes, polyamides, fluoropolymers, high density polyethylenes, polypropylenes, cellulose ethers and esters, polyacrylates and silicone containing polymers.

The relationship of particle size of milling and the fineness of the dispersed product is approximately 1/1000. The grinding-media with a particle size of 100 □m can produce the dispersed product with a fineness below 100 nm while the grinding-media with a particle size of 50 μm can produce the dispersed product with fineness below 50 nm. The fineness of the product increases with the particle size of grinding-media. However, the initial particle size of the powder desired to be dispersed is limited; those that are close to the size of the grinding-media are avoided. For the soft aggregates to be dispersed, the size of each powder particle of the soft aggregates is preferably below one third of that of the grinding-media More preferably, the size of each powder particle is preferably below one of tenth of that of the grinding-media. For the hard aggregates to be dispersed, the size of the each powder particle of the hard aggregates is preferably below one tenth of the grinding-media.

The dispersing and milling process may be dry mode, such as dry roller milling, or wet-milling. Preferably, the dispersing or milling process is wet-milling. The liquid here serving as the dispersing medium provides a space for dispersant (surfactant or dispersing facilitator) or powder particles. The liquid (or the dispersing medium) may be water, salt water, methanol, ethanol, butanol, hexane, glycerol or other organic solvents or a mixture thereof. The dispersant is selected from the well-known surfactants, and its amount is approximately 0.1 to 90% by weight of the powder.

The dispersant is related to the chemical structure and property of the powder particles to be dispersed. The dispersant usually has good surface adsorption. It means that one end of the dispersant has good affinity to the powder surface while the other end of the dispersant has good affinity to the dispersing medium. Moreover, the dispersant can stretch out in the dispersing medium to form stereo-hindrance or to generate anionic or cationic repulsive force at the end near the dispersing media to separate the dispersed powder particles and make them stable rather than gathering together. For the dispersant, the functional groups of the end near powder are preferably similar to those of powder to perform good affinity and are typically functional groups having long carbon chain, cyclic groups with saturated or unsaturated bonds, or a combination thereof. On the other hand, the functional groups of the end near the dispersing media depend on the property of the media. In most cases, the polar media such as water or aqueous solution are cooperated with the polar group such as the electronegative, electropositive group, or the group generating hydrogen bond on the end of the dispersant. For example, groups like —SO₃Na, —COONa, —(CH₂CH₂O)ₙ, —SO₄Na, and —OH are the adequate polar groups attached on one end of the dispersant. The well-known surfactants, such as anionic, cationic, or non-ionic or polymeric surfactants or their mixture, conforming the dispersion condition mentioned above are suitable for the present invention, and are preferably polyacrylate, formaldehyde condensates of sulfonated aromatic compounds, conventional alkyl or aryl polyethoxylates, polyurethane type, core-shell polymers, polyester, polyamino acid dispersant, block copolymer, photo-crosslinkable polymeric dispersants, star polymer, polyamine/fatty acid condensation polymeric dispersant, modified acrylamide oligomer dispersant, more preferably polyoxyethylene sorbitan fatty acid ester, octyl phenol polyethylene glycol ether, fatty alcohol polyethylene glycol ether, polyoxypropylene polyoxyethylene ether, fatty acid polyethylene glycol ether, castor oil polyethylene glycol ether, sulfosuccinate monoester, di-octyl sulfouccinate, dodecyl benzene sulfonate, naphthalene formaldehyde condesate, miscellaneous dialkyl ammonium methosulfate, polyoxethylene alkyl ether, polythylene glycol fatty acid, amine ethoxylate, polyoxylethylene di-styrenated phenol, Nonyl phenyl ether phosphate, polyoxyethylene di-styrenated cresol, condensated arylsulfonic acid, aromatic polyether based dispersant, alkylphenol ehtoxylates butyl glycol, or N-methyl-N-oleoyl taurate. Milling the disperse dye, fluorescence enhancing dye, dye for paint or ink, organic or inorganic flame retardant, medicine powder or crystalline functional powder according to the process of the present invention will obtain the dispersed product at a semi-micrometer or nanometer scale—particle size below 500 nm, preferably below 100 nm, or even 30 nm. The serious contamination and abrasion of grinding-media are avoided in the dispersing system of the present invention, and the products are free from color aberration.

The milling or grinding of the present invention can be achieved through any conventional mills. Suitable mills include airier mills, roller mills, ball mills, attritor mills, vibratory mills, planetary mills, sand mills, and bead mills. The best choice is the high power dispersing device which is mounted with a whirling axis center. The milling operation mode may be a batch mode, a continuous mode or a semi-batch mode.

In the batch mode, a motor and stirring blades are used to mix glass milling particles (particle size <100 nm), the dispersing media, the powder desired to be dispersed and the dispersant. Then the mixture is transferred to a conventional high-power milling device which is used for the batch mode, such as a high speed mill, a vibratory mill, a ball mill etc. to form a slurry. The slurry is dispersed at a constant interval to reduce the particle size of the powders to the expected value. After complete dispersion, the dispersed product (dispersed powder, dispersant, and dispersing media) and the grinding-medium are filtered or separated.

In the continuous mode, the glass grinding-medium (particle size <100 nm) is mixed with the dispersing media, powders desired to be dispersed and dispersant in an external mixing tank. The mixture is then continuously passed though a conventional media mill mounted with a media separating screen or space where the dispersed mixture with a particle size below 100 nm can pass by and enter circulating pipelines. After complete dispersion, the dispersed product (dispersed powder, dispersant, and dispersing media) and the grinding-medium is filtered or separated.

In the mixing mode, the glass grinding-medium (particle size <100 nm) is mixed with the dispersing media, powders desired to be dispersed and dispersant in an external mixing tank. The mixture is then continuously passed though a conventional media mill containing grinding-medium (>250 nm). The mill is fitted with a media separating screen or space where the dispersed mixture with a particle size below 100 nm can pass by and enter circulating pipelines while the larger particles stay in the mill. After complete dispersion, the dispersed product (dispersed powder, dispersant, and dispersing media) and the grinding-media are filtered or separated, for example, with a conventional filtering method such as filtering, sieving with a sieve with constant meshes or a similar method.

The milling time depends on the powder type, initial particle size, final fineness, dispersing device and dispersing operation mode. The retention time of the dispersing mixture in the mill may be used as an index. Typically, the milling time for the ball mill ranges from several days to several weeks while the operation time for the media mill is about 8 hours.

Embodiment 1 Pre-Treatment of Grinding-Media

(A) Separating the un-used media impurity: 100 g of precision glass spheres (Class V) with a particle size ranging from 53 to 45 □m (MO-SCI Specialty Products, L.L.C.) serve as grinding-media which are put in a cylindrical glass container mounted with a filter of 5 □m mesh at bottom where water is installed and an overflow hole at the top. The water influx is adjusted until the glass milling media in the container are suspended steadily, and some small particles suspended on the top do not resist the up-flowing force of the influx whereby they overflow out of the glass container. The influx rate is kept until no more small particles overflow. The un-used grinding-media (sample ID 1-1), overflowed grinding-media (sample ID 1-2) and un-overflowed grinding-media (sample ID 1-3) areseparately collected to be measured.

(B) Stirring the un-treated grinding-media at high speed and then separating the impurities: 100 g of water is mixed with 100 ml of grinding-media and stirred with a 40 mm blade at 5000 rpm to collide with each other for 10 hours. The mixture is then transferred to the separating device described in step (A) and the same separation process is carried out to collect the overflowed grinding-media (sample ID 1-4).

Results: The samples mentioned above are observed by optic microscope, and the results show that the un-used media (sample ID 1-1) contains impurities such as irregular, black, or small particles. Due to the focus stress, irregular particles with sharp angles will crash after dispersing. The black particles contain bubbles and refract light so they appear black and may be crashed under high speed milling and colliding; while the small particles are easily worn. These three kinds of particles must be removed before milling. The overflowed grinding-media (sample ID 1-2) are those small, black, or irregular particles. On the other hand, the results for the un-overflowed grinding-media (sample ID 1-3) show that the pre-treated grinding-media are homogeneous and the impurities are all removed. After the high speed stirring in step (B), the overflowed, milled irregular particles (sample ID 1-4) are separated. From these results it is known that if the impurities (irregular, black or small particle samples) are not removed before milling, they will crash in the high speed colliding during the milling process. In addition, these scraps will scrape the surface of normal media and further contaminate the dispersed products. Therefore, the pre-treated separating step is required for all kind of grinding-media or the products may be contaminated by the impurities or scraps.

Embodiment 2 Grinding-Media and Milling Tank Suitability Test

100 g of yttrium-zirconium composite grinding-media with a density of 6 g/cm³ and a particle size of 38 to 75 □m is mixed with the same volume of water. The mixture is stirred with a 40 mm blade at 5000 rpm to collide with each other for 10 hours.

Results: The results are observable by the naked eye, and the stirring solution starts to demonstrate black after around 2 hours; the darkness increases with time. Because the grinding-media are white, it is assured that black media do not result from media scraps; moreover, the milling container is a stainless steel tank which is softer than grinding-media so the color alteration results from the abrasion of the tank surface by grinding-media. Glass beads (50 □m) are tested by the same process and no color alteration occurs resulting from milling tank abrasion. These results show that though the gravity and colliding force of the single grain below 100 □m are small, the dense yttrium-zirconium composite grinding-media still abrade the stainless steel tank. Therefore, such dense grinding-media are not suitable for the stainless steel tank despite the tanks cost-effectiveness; thus, the glass grinding-media are better than the dense yttrium-zirconium composite grinding-media.

Embodiment 3 The Milling and Dispersing Process of the Present Invention

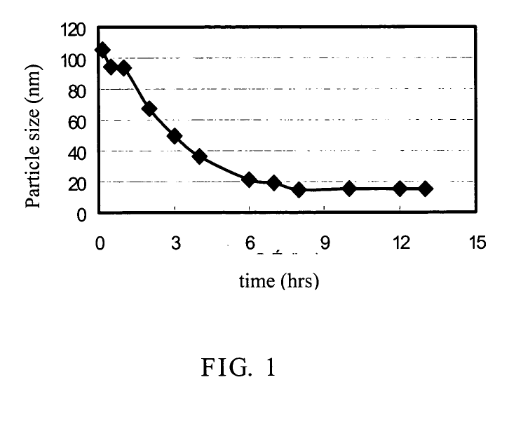

The grinding-media formulates are listed in table 1. Water and dispersant are put in 1 L milling tank and agitated by a colwes-type blade with a diameter of 40 mm to 50 mm and an ULTRA-TURRAX™ T50 basic mixer (IKA) at 300 rpm till dissolved. The pigments are then slowly added in the solution and stirred for about 1 hour. The grinding-media are slowly added in said solution, and after the media are rinsed completely, the rotation speed is gradually increased until the rate of blade is 15 m/s (rotation speed is about 5000 to 8000 rpm). The milling and dispersing process is continued; the sample is collected every hour, and the particle size of the sample is measured by a Malvern™ 4700 to obtain the particle size alteration information during the dispersing process. The results shown in FIG. 1 demonstrate that using the glass grinding-media, the dispersed particle size can reach a high dispersing degree, ie 30 nm or less, within 6 hours. Once the expected particles size (<30 nm) is achieved, the dispersant is diluted by water till the amount is 10 wt % of pigments. The nano-scale dispersing solution and grinding-media are then separated with a sucking device and a filter head with an aperture of less than the particle size of the grinding-media. The filtrate is further filtered by a filter of which the aperture is 1 □m.

### COMPARISON EXAMPLE 1

### The Dispersion of 250 □m Polystyrene Grinding-Media

The grinding-media formulates are listed in table 1. These components are milled and dispersed as in the process in embodiment 3 except the rotation speed is 1900 rpm, the diameter of the blade is 60 mm, the volume of the milling tank is 600 ml, and the milling time is 29 hours.

### COMPARISON EXAMPLE 2

### The Dispersion of 1 mm Yttrium-Zirconium Composite Grinding-Media

The grinding-media formulates are listed in table 1. These components are milled and dispersed as the process performed in embodiment 3 except the rotation speed is 1650 rpm, the diameter of the blade is 50 mm, the volume of the milling tank is 600 ml, and the milling time is 55 hours.

The product purity is measured by inductive coupling plasma emission spectrometry and the metal content in the dispersed product is further analyzed. Thus, according to the measuring result, the contamination caused by the scratch of the tank wall and the abrasion condition of the grinding-media after dramatical collision between each other can be understood. The results are shown as table 2.

TABLE 1

| | Pigment | | Dispersing | |
|---|---|---|---|---|
| Example | content* (g) | Dispersant | media | Grinding-media |
| Embodiment | 42.16 | Syn Fac 8216 | Deionized | Precision Glass Spheres |
| 3 | | (Milliken) 25.3 g | water | (Class V), particle size |
| | | | 143.2 g | range 53-45 μm (MO-SCI |
| | | | | Specialty Products, L.L.C.) |
| | | | | 570.7 g |
| Comparison | 28.3 | Joncryl 678 | Deionized | Polystyrene, average |
| example 1 | | (Johnson) 28.3 g | water | particle size 250 μm |
| | | | 132.3 g | (Glen-Mill) 243.1 g |
| Comparison | 28.3 | Joncryl J678 | Deionized | Zirconium oxide 1 mm |
| example 2 | | (Johnson) 34.0 g | water | (Jie-Nan Co.) 817.4 g |
| | | | 126.6 g | |

*Using Sunfast ™ Quinacridone Pigment (Red 122, Sun Chemical Co.)

TABLE 2

| | | Comparison | Comparison |
|---|---|---|---|
| | Embodiment 3 | example 1 | example 2 |
| | (GIM002) | (HCT029) | (DFS061) |
| Grinding-media | Glass 50 μm | PS | Zircon |
| (diameter) | | 250 μm | 1 mm |
| Pigment content wt % | 12.0 | 10.8 | |
| Average particle size | 13.6 | 47.3 | 68.6 |
| (nm) | | | |
| Milling time (hrs) | 20 | 29 | 55 |
| Metal content (ppm) | 448.49 | 444.3 | 900.69 |

The dispersing process carried out in comparison example 2 is the same as the process in embodiment 3, but the metal contamination is double or more. If the dispersed product of comparison example 2 is observed, the precipitation occurs after several days. The precipitates are white, coincident with the grinding-media, which is beyond the anticipated result (ie, no precipitation occurs in the other samples). Therefore, using the pre-treated grinding-media will cause less abrasion because their particle size is small and the single grain dispersing media kinetic energy is less. Therefore, if they are used with a stainless steel tank, the metal contamination is less.

Embodiment 4 The comparison between the ink-jet ink produced from the dispersing solution of the present invention and the traditional semi-micro pigment dispersing solution

For the dispersed product is applied as ink-jet ink, the total content of calcium, magnesium and chloride is controlled below 100 ppm. The product of embodiment 3 is analyzed by ion chromatography, and the concentrate of [Mg²⁺] is 46.61 ppm, [Ca²⁺] is 14.87 ppm, [Cl⁻] is 16.64 ppm; the total content is 78.13 ppm. The pigment concentration of this test sample is 12%, four fold of conventional ink, so after allocating, the total content is still acceptable. From the above description, the grinding-media of the present invention may be used to disperse the ink-jet ink for high quality printing.

The magenta pigment dispersing solution (nano-scale) of the present invention or traditional magenta pigment dispersing solution (semi-micro scale) is mixed with 4.08% of a pigment dispersant (pigment content is about 10 wt %), 10.42% of moisturizer (diethylene glycol), 0.1% of antiseptic and water to form ink-jet ink. These two pigment dispersing solutions prepared above is used in thermal bubble ink jet printing, and their characters are listed on table 3.

TABLE 3

| | Ink produced from the | Ink produced from the |
|---|---|---|
| | dispersing solution of the | tradition semi-micro |
| Characters | present invention | dispersing solution |
| Viscosity (cps) | 1.64 | 2.08 |
| Surface tension | 48 | 42 |
| (dyne/cm) | | |
| pH | 7.15 | 8.2 |
| Particle size | 19.6 | 102.2 |
| Color density | 0.91 | 0.85 |

The ink produced from the dispersing solution of the present invention has high surface tension and good preparation flexibility. The particle size of the ink produced from the dispersing solution of the present invention is small so they are easily filtered without obstructs, and the color saturation is high.

Embodiment 5 Mixing the Traditional Pigment Dispersion of the Present Invention to Produce Color Coating for Artificial PU Leather

The traditional pigment dispersion (traditional pigment dispersing solution) and the dispersing solution of the present invention are compared as table 4:

TABLE 4

| | | Traditional pigment | Dispersing solution of |
|---|---|---|---|
| | | dispersion solution | the present invention |
| Appearance | High | The natural color, | The natural color is |
| | conc. | darker with muddy, | black, saturated |
| | | unsaturated | |
| | Low conc. | The natural color, | The natural color is |
| | | opaque, a liffle muddy | limpid, similar to the |
| | | | pigment |

| | | |
|---|---|---|
| Viscosity (cps) | Hundreds to more | <20 |
| | than ten thousand | |
| Average particle size | >100 nm | <30 nm |
| | to micrometer | |

The results show the disadvantages of traditional color paste such as muddy and unsaturated color, high viscosity and large particle size while the advantages of the dispersing solution of the present invention are such as limpid and saturate color, low viscosity and particle size below 30 nm.

The traditional color paste is mixed with the pigment of the present invention, 8% of pigment dispersant, 10.42% of aqueous PU resin, a small amount of moisturizer (1%) and water. The mixture is spread on gray PU leather by a coating bar and then being dried at 70° C. for 5 min. The results are observable by naked eye and shown in table 5.

TABLE 5

| The mixing weight ratio of pigments | | | |
|---|---|---|---|
| | The nano-pigment of | The characters of coating | |
| | the present | Hiding | Color |
| IW 6540 | invention | power | saturation |
| 100 | 0 | Bad | Bad |
| 99 | 1 | Excellent | Excellent |
| 97 | 3 | Excellent | Excellent |
| 95 | 5 | Acceptable | Acceptable |
| 90 | 10 | Acceptable | Acceptable |

IW 6540 is an aqueous color paste purchased from Tatung Co. From table 5 it is known that adding 1% to 3% pigment of the present invention highly increases the hiding power and color saturation.

Although the present invention has been explained in relation to its preferred embodiment, it is to be understood that many other possible modifications and variations can be made without departing from the spirit and scope of the invention as hereinafter claimed.

What is claimed is:

1. A grinding process for forming a slurry of nanoparticles, comprising the following steps:
(a) forming a mixture by mixing a matrix, a dispersant and dispersing media together;
(b) adding a pre-treated grinding-medium into said mixture;
wherein said pre-treated grinding-medium are glass beads with an average particle diameter of less than 100 □m;
(c) milling or grinding said mixture; and
(d) separating said grinding-medium from said mixture to obtain a slurry of nanoparticles.

2. The process as claimed in claim 1, wherein said matrix is selected from the group consisting of insoluble dyes, pigments, crystalline organic molecules, polymers, or medicine powders.

3. The process as claimed in claim 1, wherein said dispersant is selected from the group consisting of anionic surfactants, cationic surfactants, nonionic surfactants and polymeric surfactants and a mixture thereof.

4. The process as claimed in claim 1, wherein at least one dispersing media is selected from a group consisting of water, salt water, methanol, ethanol, butanol, hexane, ethylene glycol and mixture thereof.

5. The process as claimed in claim 1, wherein said pre-treated grinding-medium is sieved out by an overflow method.

6. The process as claimed in claim 1, wherein the average particle diameter of said grinding-medium ranges from 50 to 1000m.

7. The process as claimed in claim 1, wherein the density of said grinding-medium ranges from 1 to 3 g/cm³.

8. The process as claimed in claim 1, wherein said mixture in step (c) is grounded until the average particle diameter of said matrix is less than 100 nm.

9. The process as claimed in claim 1, wherein said grinding-medium is in a ball-shape.

10. The process as claimed in claim 1, wherein said milling or grinding is carried out in a mill having a stainless steel mixing tank and a stirring blade.

11. The process as claimed in claim 10, wherein said mill is an airier mill, a roller mill, a ball mill, an attritor mill, a vibratory mill, a planetary mill, a sand mill or a bead mill.

12. The process as claimed in claim 1, wherein said milling or said grinding is achieved in a batch mode, a continuous mode or a semi-batch mode.

13. The process as claimed in claim 1, wherein said slurry of nanoparticles is used in the manufacturing of pigment dispersion, dyes for paints, dyes for polymers or dyes for inks.

14. A pigment dispersion, comprising:
0.1 to 70 wt % of a pigment having an average particle diameter of less than 100 nm;
0.1 to 30 wt % of dispersant; and
40 to 90 wt % of water;
wherein said pigment is formed by milling or grinding a mixture of a matrix, said dispersant and a dispersing medium with glass beads having an average particle diameter of less than 100 □m.

15. The pigment dispersion as claimed in claim 14, wherein said dispersant is selected from a group consisting of anionic surfactants, cationic surfactants, nonionic surfactants, polymeric surfactants and a mixture thereof.
